(19) United States
(12) Patent Application Publication
(10) Pub. No.: US 2026/0273599 A1
(43) Pub. Date: Sep. 17, 2026

(54) METHOD AND ARRANGEMENT FOR REGENERATING GREEN SAND

(71) Applicant: RESAND OY, Nuutajärvi (FI)

(72) Inventors: Toni WESIN, Nuutajärvi (FI); Jukka NIEMINEN, Nuutajärvi (FI)

(21) Appl. No.: 19/167,097

(22) PCT Filed: Mar. 19, 2024
(86) PCT No.: PCT/FI2024/050128

§ 371 Date: Sep. 19, 2025

(30) Foreign Application Priority Data
Mar. 22, 2023 (FI) 20235336

(51) Int. Cl. B09B 3/40

(52) U.S. Cl. CPC B09B 3/40

(57) ABSTRACT

A method and an apparatus for regenerating green sand, wherein when regenerating green sand, focusing a first mechanical process to the green sand, focusing a thermo-mehanical process to at least part of a green sand fraction that has undergone the first mechanical process, and focusing a second mechanical process to at least part of the green sand fraction that has undergone both the first mechanical process and the thermo-mechanical process.

### BACKGROUND OF THE INVENTION

The invention relates to the regeneration of green sand i.e. sand that comprises a clay-based binder.

Green sand i.e. sand comprising a clay-based binder is used in metal foundries for mould manufacturing, that is, for manufacturing moulds and cores needed during the casting of metal. This foundry sand used in foundries is typically sand processed of green sand, whereby a fraction suitable of its grain size for the intended use in question has been selected of green sand, to which is further added, e.g., a clay-based binder. The clay-based binder comprises clay, typically bentonite, and one or more additives added to clay, typically at least carbon. By means of this clay-based binder, sand is mouldable for forming a desired mould or core.

One of the biggest challenges and problems of foundries is the final disposal of used moulding sand remaining from moulds. As much foundry sand used when manufacturing castings is on average generated as finished cast products. Previously, used foundry sand was typically transported to a landfill site, but nowadays, as reserves of natural sand are decreasing and environmental regulations are tightening, the recycling of used foundry sand to be re-used either as foundry sand or for some other use is on the increase.

However, the recycling of used foundry sand to be re-used, either as foundry sand or for some other use, typically requires the regeneration of used foundry sand such that the properties of reclaimed foundry sand are acceptable for re-use either as foundry sand or for some other use.

For example, mechanical or thermal processes have been utilised for the regeneration of used foundry sand, which processes have aimed at removing impurities in the used sand or the binder that comprises clay and additive that dis-able sand to function in its previous use. In order to be able to utilise natural re-sources more effectively, there is an even greater need to the more efficient regeneration of used foundry sand, whereby a greater part of at least once used sand can be recycled and the use of natural sand decreased.

### BRIEF DESCRIPTION OF THE INVENTION

The object of the invention is to provide a new type of method and apparatus for regenerating green sand.

The solution according to the invention is characterised by what is dis-closed in the independent claims.

The invention is based on regenerating green sand by applying to it different processes in a specific order, wherein each process focuses on sand in such a step where a previous process has been applied to sand, which assists in regenerating sand during the next process. In the solution according to the invention, applying a first mechanical process to green sand, applying a thermo-mechanical process to at least part of a green sand fraction that has undergone the first mechanical process, and applying a second mechanical process to at least part of the green sand fraction that has undergone both the first mechanical process and the thermo-mechanical process.

The first mechanical process, the thermo-mechanical process and the second mechanical process following each other regenerate foundry sand that comprises a clay-based binder efficiently. Furthermore, after the first mechanical process, the possible recovery of the used binder, i.e. used clay and an additive, particularly carbon, separated from it increases the total quantity of various recovered and re-usable materials.

Some embodiments of the invention are presented in the dependent claims.

### BRIEF DESCRIPTION OF THE DRAWINGS

The invention will now be described in more detail in connection with preferred embodiments and with reference to the accompanying drawings, in which:

FIG. 1 schematically shows a method for regenerating green sand, and

FIG. 2 schematically shows an apparatus for regenerating green sand.

For reasons of clarity, some embodiments of the invention are illustrated in the figures in a simplified form. Similar parts are indicated in the figures by the same reference numbers.

### DETAILED DESCRIPTION OF THE INVENTION

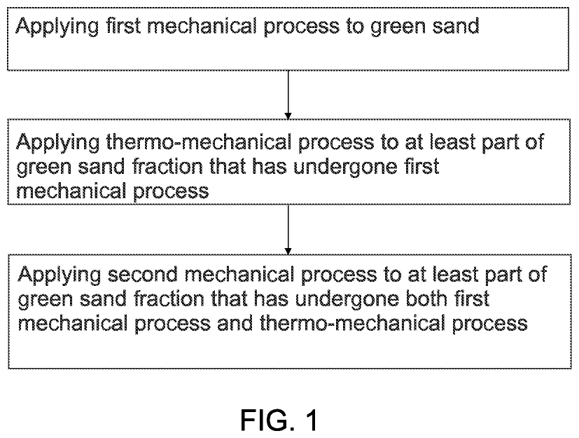

FIG. 1 schematically shows a principal method according to the solution for regenerating green sand, that is, sand comprising a clay-based binder, wherein the clay-based binder comprises clay, typically bentonite, and one or more additives, such as e.g. carbon, added to the clay. Thus, regenerable green sand consists of sand grains with a layer of the clay-based binder on their surface. Regenerable green sand can comprise e.g. sand, that comprises a clay-based binder, originating from a metal foundry, used for casting. Regenerable green sand can also comprise unused sand, that comprises a clay-based binder, left over from the manufacture of a casting mould or core. Typically, the clay-based binder comprises bentonite but the use of other clay-based binders is also possible in green sand.

With reference to FIG. 1, a method according to the solution comprises at least the following steps:
1) applying a first mechanical process to green sand,
2) applying a thermo-mechanical process to at least part of a green sand fraction that has undergone the first mechanical process, and
3) applying a second mechanical process to at least part of the green sand fraction that has undergone both the first mechanical process and the thermo-mechanical process.

The purpose of the first mechanical process applied to green sand is to mechanically release clay-based binder and carbon that is typically included in the binder from the regenerable green sand.

The purpose of the thermo-mechanical process applied to at least part of the green sand fraction that has undergone the first mechanical process is to focus to said green sand fraction both a mechanical process for separating carbon from the binder remaining in said green sand fraction and a thermal process for burning said carbon and for evaporating crystal water in the binder still remaining in said green sand fraction.

The purpose of the second mechanical process applied to at least part of the green sand fraction that has undergone both the first mechanical process and the thermo-mechanical process is to mechanically separate binder still remaining in it from said green sand fraction in order to provide regenerated sand.

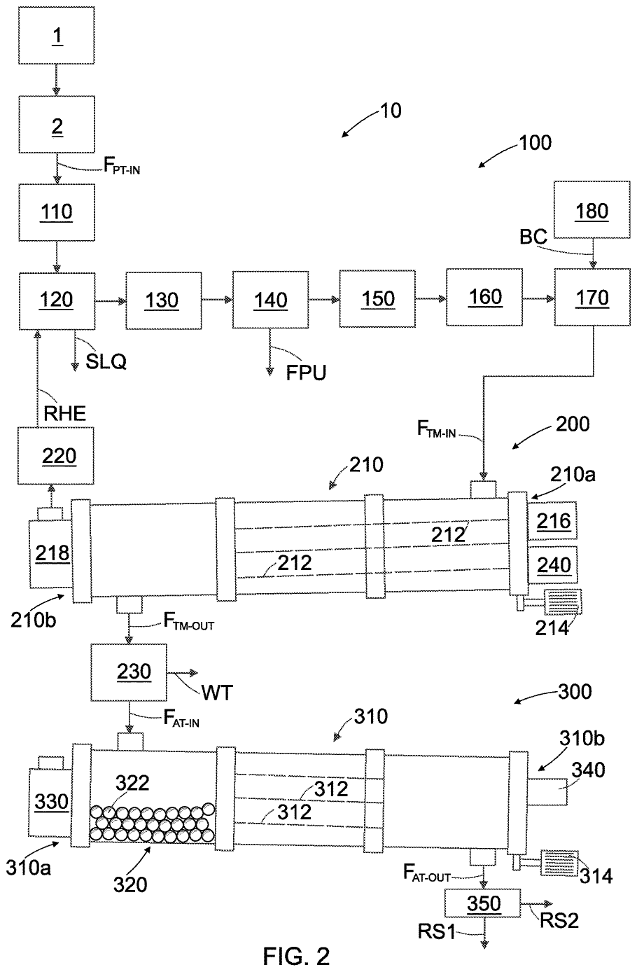

FIG. 2 schematically shows an apparatus 10 for regenerating green sand. The apparatus 10 of FIG. 2 comprises a green sand pre-processing step 100, wherein the first mechanical process is also applied to the regenerable green sand in addition to some other processes. The apparatus 10 of FIG. 2 further comprises a green sand thermo-mechanical process step 200, wherein the thermo-mechanical process is further applied to at least part of the green sand fraction that has undergone the first mechanical process. Furthermore, the apparatus 10 of FIG. 2 comprises a green sand further processing step 300, wherein the second mechanical process is also applied to at least part of the green sand fraction that has undergone both the first mechanical process and the thermo-mechanical process in addition to some other processes. The apparatus 10 of FIG. 2 is only intended to schematically describe the construction and operation of the apparatus 10 and, depending on various embodiments of the apparatus 10, the configuration of the apparatus 10 can differ from the one of FIG. 2.

The green sand pre-processing step 100 comprises at least one feeding device 110 which is configured to receive regenerable green sand and to feed it forward in the regeneration process formed by the apparatus 10. The feeding device 110 can comprise e.g. a feed bin or container and a conveyor arranged in connection with it, whereby the feed bin or container in question is configured to receive regenerable green sand and to feed it by means of the conveyor in question forward in the regeneration process.

Green sand fed to the green sand pre-processing step 100, i.e. the feeding device 110, is preferably for the most part monogranular sand, that is, sand with as few lumps and various impurities, such as e.g. dust. Therefore, there can be before the actual apparatus 10 for regenerating green sand at least one crushing device 1 which is arranged to disintegrate e.g. moulds and cores removed from casting use such that the sand fed to the feeding device 110 would have as few lumps as possible. Additionally, after the crushing device 1 but before the actual apparatus 10 for regenerating green sand, there can be at least one separating device 2 which is arranged to separate dust or other impurities that are lighter than sand grains from the green sand fed to regeneration away from the green sand fed to the feeding device 110. Said separation can be implemented by utilising e.g. air classifying, whereby said separating device 2 can be e.g. a cyclone. The feed of green sand to the pre-processing step 100 is shown schematically in FIG. 2 by an arrow with designation F_{PT-IN}.

The green sand pre-processing step 100 comprises at least one first processing device 130 which is arranged to generate mechanical impacts applied to green sand fed to the regeneration process for focusing a first mechanical process to green sand. The first processing device 130 can be e.g. a grinder which is arranged to break up or prepare green sand for separating the clay-based binder and carbon possibly contained by it from the mechanically regenerated green sand. Said grinder can be e.g. a substantially vertical column grinder which can comprise e.g. a screw-like rotatable blade or one or more vanes for creating said mechanical impacts to the green sand being processed. Then, impacts focused by the blade, vane or vanes directly on green sand and the mutual rubbing of sand grains occurring within green sand release the binder and the carbon possible contained by it from the surface of sand grains. Alternatively, said grinder can be a substantially horizontal grinder mill which can comprise e.g. two drums inside one another rotating in relation to each other. Then, said drums create mechanical impacts to green sand fed between the drums, whereby both the impacts focused by the drums directly to green sand and the mutual rubbing of sand grains occurring inside the green sand being ground release the clay-based binder and the carbon possibly contained by it from the surfaces of the sand grains.

The first mechanical process produced by said at least one first processing device 130 is preferably focused on dry green sand, i.e. such green sand that contains no moisture or has at least very small moisture content, that is, preferable below 1%. Because the moisture content of green sand fed from the casting process to regeneration is typically above 1%, conventionally 1-2%, it is possible to remove moisture from green sand fed to the first processing device 130 by at least one moisture removal device 120 such that green sand fed to the first processing device 130 contains no moisture or has very little moisture, that is, its moisture content preferably is below 1%.

In the moisture removal device 120, moisture i.e. water or an additive of water and some additive is removed from green sand. The moisture removal device 120 can comprise e.g. at least one liquid-solids separator for separating liquid, i.e. water or an additive of water and some additive having ended up in it from green sand, from green sand. Said separated liquid is shown in FIG. 2 schematically by an arrow designated by SLQ. Liquid SLQ separated in the moisture removal device 120 can be fed to further processing e.g. for recovering chromite ended up in it. The moisture removal device 120 can also comprise, at least in addition to or instead of one liquid-solids separator, at least one heater to evaporate moisture out of green sand fed to the first processing device 130. Said heater can utilise e.g. heat recovered in the thermo-mechanical processing step 200, such as shown in FIG. 2 schematically by an arrow designated by RHE. The moisture removal device 120 thus aims at removing moisture of green sand fed to the first processing device 130 such that the moisture content of green sand fraction going forward in the regeneration process from the moisture removal device 120, fed to the first mechanical process is preferably below 1%. If green sand fed to the regeneration process does not contain moisture, there is no need for the moisture removal device 120.

According to an embodiment, the first processing device 130 can also be combined to the feeding device 110. Then, the moisture removal device 120 possibly included in the apparatus 10 is located before said combination of the feeding device 10 and the first processing device 130 in the flow direction of regenerable green sand.

From the first processing device 130, the green sand fraction that has undergone the first mechanical process is led to at least one separating device 140 which is arranged to separate the clay-based binder and the carbon released from the clay-based binder from the green sand fraction that has undergone the first mechanical process. The clay-based binder released from the green sand and the carbon released from the binder can be recovered for further processing and/or utilisation, such as schematically shown in FIG. 2 by an arrow designated by FPU. The separation of the clay-based binder released from green sand and the carbon released from the binder from the green sand that has undergone the first mechanical process can be implemented e.g. by means of air classification, whereby said separating device 140 can be e.g. a cyclone.

The green sand fraction coming from the separating device 140, having undergone the first mechanical process, and from which as large as possible share of the clay-based binder released from green sand and the carbon released from the binder is guided to at least one vibrator 150, wherein sand is brought into a vibrating motion with the purpose of breaking lumps still existing in the sand in this step in order to decrease their number or size.

From the vibrator 150, the green sand that has undergone the first mechanical process is guide to at least one magnetic separator 160 which is arranged to separate ferromagnetic materials, such as e.g. chromite or steel, which can re-main in green sand collected from a foundry, from the green sand fraction that has undergone the first mechanical process. Said magnetic separator 160 can comprise one or more permanent magnets or electromagnets depending on the quantity of the material flow being processed or the required separation capability. According to an embodiment, the magnetic separation implemented by the magnetic separator 160 can also be implemented in connection with the vibrator 150.

From the magnetic separator 160, the green sand fraction that has undergone the first mechanical process is fed forward to at least one mixing device 170 where an additive is added and mixed to the green sand fraction that has undergone the first mechanical process, the purpose of which is to promote the removal of alkali metals or compounds remaining in the clay-based binder, such as potassium, from the green sand being regenerated. Said additive can be e.g., a sub-stance containing aluminium silicate Al₂SiO₅ (Al₂O₃·SiO₂) or aluminium hydroxy silicate (OH)₄ (Al₂O₃·2SiO₂·2H₂O). The purpose of said additive is to increase the melting temperature of alkali metal oxides or compounds in the clay-based binder remaining in the green sand being regenerated and thus prevent said alkali metals and compounds from reacting with silicon dioxide on the surface of a sand grain and from adhering to the surface of the sand grain. The additive thus reacts with the alkali metals or compounds in the clay-based binder remaining in the green sand being regenerated and forms at least partially melting alkali salts in the temperature used in the thermo-mechanical process, and by means of said at least partially melted alkali salts, promotes the removal of impurities comprising said alkali metals or compounds from the green sand being regenerated during the thermo-mechanical processing step 200. Said mixing device 170 can be e.g. a screw feeder. Said additive can be added directly to the mixing device 170, such as schematically shown in FIG. 2, or to a green sand fraction to be fed there by at least one dosing device 180, such as schematically shown by an arrow designated by BC in FIG. 2. The content of said additive in the composition formed by the green sand being regenerated and the additive can be e.g. 0.5-3 percentage by weight. The higher the content of the used additive in the composition of the green sand and the additive is, the lower will be the pH and electric conductivity of regenerated sand. Because a significant quantity of binders has been removed from the green sand being regenerated already during the first mechanical process focused to it, the quantity of the additive to be added to green sand fed to the thermo-mechanical regeneration in relation to the quantity of said green sand can be kept very small.

A composition of the green sand fraction that has passed the first mechanical process and the additive mixed to it is fed to the thermo-mechanical processing step 200, wherein the green sand fraction in question is further regenerated by focusing both a thermal and a mechanical process simultaneously to it. In the apparatus 10 of FIG. 2, the thermo-mechanical processing step 200 is performed by a heatable rotary kiln 210, which can be next referred to as a kiln 210. The heatable rotary kiln 210 may be called heatable and rotatable rotary kiln. The heatable rotary kiln 210 may be called heated rotary kiln.

The heatable rotary kiln 210 of FIG. 2 is substantially cylindrical and it comprises a first end 210a and a second end 210b substantially opposite to the first end 210a in the longitudinal direction of the kiln 210. Green sand fed from the pre-processing step 100 to the green sand thermo-mechanical processing step 200 is fed to the kiln 210 at its first end 210a, such as schematically shown by an arrow designated by FTM-IN in FIG. 2, and the green sand that has passed the kiln 210 i.e. passed the thermo-mechanical processing step 200 is removed from the kiln 210 at its second end 210b, such as schematically shown by an arrow designated by FTM-OUT in FIG. 2.

On the inner wall of the kiln 210, there is typically one or more lifters 212, extending in the direction of the diameter of the kiln 210 from the inner wall of the kiln 210 at least partially toward the centre of the kiln and in the longitudinal direction of the kiln 210 substantially from the direction of the first end 210a of the kiln 210 into the direction of the second end 210b of the kiln 210. The lifters 212 are shown in FIG. 2 very schematically by a dashed line. Each lifter 212 is arranged, when the kiln 210 rotates around its rotation axis, to catch at least part of green sand fed to the kiln 210 along with it such that said part of green sand moves along the kiln 210 on the inner circle of the kiln 210 until the part in question of the sand falls back onto the bottom of the kiln 210. The kiln 210 is rotated by a variable speed motor 214 such that the rotation speed of the kiln 210 is typically about 5-20 rotations per minute, depending e.g. on the diameter and/or fill factor of the kiln 210.

The lifters 212 can be arranged to a tilted position schematically shown in FIG. 2 to guide and increase the passing of green sand from the direction of the first end 210a of the kiln 210 towards its second end 210b. A similar effect can be provided or it can be intensified by arranging the kiln 210 in a tilted position such that the first end 210a of the kiln 210 is at a higher position in relation to the second end 210b of the kiln 210, such as schematically shown in the embodiment of FIG. 2. The total inclination degree provided by said position of the lifters 212 and/or the kiln 210 from the first end 210a to the second end 210b of the kiln 210 can be e.g. 0.5-5 degrees.

The kiln 210 of FIG. 2 further comprises at least one heating device 216 which is arranged to heat the inner volume of the kiln 210 and the green sand fraction fed to the kiln. In FIG. 2, the heating device 216 is arranged to the first end 210a of the kiln 210 but, alternatively, it would be possible to arrange the heating device 216 to the inner volume of the kiln 210 e.g. in the vicinity of the first end 210a of the kiln 210. The heating device 216 can be e.g. a gas burner, a plasma gas burner, a liquid gas burner or any other burner. Instead of or in addition to the burner, it is also possible to use some other device to heat the inner volume of the kiln 210 and the green sand fraction fed to the kiln 210. The first end 210a may be called a feed end.

The kiln 210 of FIG. 2 additionally comprises at least one air exhaust device 218, such as e.g. an air extractor or an exhaust blower which is arranged to remove flue gases and fines, such as flue dust, created during the processing of the green sand fraction from the inner volume of the kiln 210. In FIG. 2, the air exhaust device 218 is arranged to the second end 210b of the kiln 210 but, alternatively, it would be possible to arrange the air exhaust device 218 in the inner volume of the kiln 210 e.g. in the vicinity of the second end 210b of the kiln 210. In connection with the air exhaust device 218 or its flue gas channel, it is possible to arrange at least one heat recovery device 220 which is arranged to recuperate heat from the flue gases extracted from the kiln. The recovered heat can be utilised e.g. in a way described above in the green sand pre-processing step 100 to remove moisture from the green sand being processed and/or to pre-heat the green sand fraction fed to the thermo-mechanical processing step 200. The power of the air exhaust device 218 is adjusted e.g. based on the fill factor of the kiln 210 such that the quantity of air flowing through the kiln 210 is e.g. about 1,000-3,000 normal cubic metres per hour. Said air can flow inside the kiln 210 e.g. through the same channel where the green sand fraction fed to the thermo-mechanical process is fed to the kiln 210 or through one or more air delivery channels 240 arranged separately in connection with the kiln 210.

In the apparatus 10 of FIG. 2, a green sand fraction, that has undergone the first mechanical process and to which the above-mentioned additive is added, is fed to the kiln 210 at its first end 210b, whereby the green sand fraction is question passes preferably towards the bottom of the kiln 210 through a flame of a burner used as the heating device 216, whereby the heating of the green sand fraction in the kiln 210 starts effectively. Simultaneously, the kiln 210 is rotated by the rotating motor 214, whereby each lifter 212 is arranged to catch at least part of the green sand fraction fed to the kiln such that the part of the green sand fraction in question moves along the kiln 210 on the inner circle of the kiln 210 until it falls back onto the bottom of the kiln 210, sand grains thus forming a sort of a sand cloud inside the kiln 210. This forming of the sand cloud enables the heating of the green sand fraction substantially evenly in the volume of the kiln 210. The temperature of the green sand fraction processed in the kiln 210 can be measured by a temperature sensor and the measured temperature in question can be utilised for the adjustment of e.g. the power of the heating device 216 and/or the rotation speed of the kiln 210 such that the green sand fraction will reach a temperature and a lead time suitable in terms of regeneration in the kiln 210. The temperature of the green sand fraction in the kiln 210 during its thermo-mechanical process is preferably about 500-850° C. and its lead time about 10-60 minutes.

The rotation of the green sand being regenerated along the kiln 210 and its falling onto the bottom of the kiln causes mechanical impacts focused to the green sand being regenerated, that is, a mechanical process focused to the green sand fraction being processed in the kiln, from the effect of which, clay-based binder releases from the surface of sand grains and dust containing carbon releases from the clay-based binder. Carbon released from the clay-based binder burns in the kiln 210, which decreases the quantity of dust created in the process. Flue gases created in burning and unburned fines along with them are extracted from the kiln through the air exhaust device 218.

The heating of the green sand being regenerated in the kiln focuses a thermal treatment to the green sand fraction processed in the kiln, from the effect of which, crystal water in the clay-based binder remaining on the surface of a sand grain evaporated from the binder. When said crystal water evaporates from the binder, it is easier to release the binder from the surface of the sand grain in the further processing step 300 following the thermo-mechanical processing step, wherein a second mechanical process is focused to at least part of the green sand fraction that has passes the thermo-mechanical processing step 200.

Such as already mentioned above, an aluminium silicate based additive is mixed to the green sand fraction fed to the kiln, the purpose of which is to promote the removal of alkali metals or compounds, such as e.g. potassium, remaining in the clay-based binder from the green sand being regenerated such that the additive reacts with alkali metal oxides or compounds in the binder remaining in the green sand fraction fed to the kiln 210 thus forming in the process temperature of the sand in the kiln 210, such as e.g. at the temperature of 500-850° C., at least partially melting alkali salts. At least partially melted alkali salts are created in the green sand fraction processed in the kiln 210, whereby impurities originating from the binder in the green sand being regenerated adhere to the partially or totally melted alkali salts and form grains when adhered together. Said grains further collect from the green sand fraction being regenerated both sand grains and impurity particles still remining in the green sand fraction thus forming agglomerates that resemble grains with a diameter of e.g. about 5-10 millimetre, which can be separated from the green sand that exits the kiln 210 in known ways, such as e.g. by sieving.

The adding of an additive containing aluminium silicate to a green sand fraction being regenerated in the thermo-mechanical process thus makes impurities in the sand to agglomerate and form, depending on the apparatus used for the themal-mechanical process and/or its method of application, agglomerates resembling grains with a diameter of e.g. about 5-10 millimetres, which pass along the sand being regenerated and transport alkali metals or compounds adhered to them and other impurities along them until they are separated from the processed sand. The use of the rotary kiln 210 for the thermo-mechanical process of the green sand fraction promotes the contact of different particles to each other and thus enables these particles sufficiently suitable impacts for the forming of said grains.

The green sand coming out of the second end 210b of the kiln 210 and the agglomerates still remining in it are fed to at least one separation device 230 which is arranged to separate the agglomerates created in said green sand thermo-mechanical process out of the green sand fraction coming from the kiln 210 before the second mechanical process is focused to the green sand fraction coming out of the kiln 210 i.e. the green sand fraction that has undergone both the first mechanical process and the thermo-mechanical process. Said separation device 230 can comprise e.g. one or more sieves the meshes of which are dimensioned such that said agglomerates do not pass the sieve set. The green sand fraction that has passed the separation device 230 forms the green sand fraction that has undergone both the first mechanical process and the thermo-mechanical process to be fed to the further processing step 300, that comprises the second mechanical process, which fraction is fed forward in the regeneration process to the further processing step 300, such as schematically shown by an arrow designated by F_{AT-IN} in FIG. 2. The agglomerates separated by the separation device 230 are removed from the regeneration process as waste to further processing, such as schematically shown by an arrow designated by WT in FIG. 2.

The green sand fraction that has undergone both the first mechanical process and the thermo-mechanical process is thus fed to the further processing step 300, wherein the green sand fraction in question is further regenerated by focusing the second mechanical process to it. In the apparatus 10 of FIG. 2, the second mechanical process is performed in a rotary kiln 310, that simultaneously constitutes a cooling device, i.e. a cooling kiln, for cooling the sand fraction having heated in the thermo-mechanical process. Said in another way, the second mechanical process is performed in the cooling kiln 310 for cooling the sand fraction having heated in the thermo-mechanical process.

The rotary kiln 310 of FIG. 2 is substantially cylindrical and it comprises a first end 310a and a second end 310b that is substantially opposite to the first end 310a in the longitudinal direction of the kiln 310. Green sand fed from the green sand thermo-mechanical processing step 200 to the green sand further processing step 300 is fed to the kiln 310 at its first end 310a, such as schematically shown by an arrow designated by F_{AT-IN} in FIG. 2, and the regenerated clean sand that has passed the kiln 310 i.e. that has also passed the second mechanical processing step is removed from the kiln 310 at its second end 310b, such as schematically shown by an arrow designated by F_{AT-OUT} in FIG. 2. The kiln 310 is rotated by the variable speed motor 314 such that the rotation speed of the kiln 310 is typically about 5-20 rounds per minute and the lead time of the sand processed in the kiln 310 through the kiln 310 is about 5-30 minutes, depending on e.g. the diameter and/or the fill factor of the kiln 310.

The kiln 310 of FIG. 2 comprises at least one second processing device 320 in the first part of the kiln 310 in the vicinity of the first end 310a, which device is arranged to produce mechanical impacts focused to the green sand fed to the kiln 310 for focusing the second mechanical process to said green sand. The second processing device 320 can be e.g. a grinder that is arranged to grind the green sand fed to the kiln 310 for mechanically releasing the clay-based binder still possibly remaining in it from the green sand fraction being regenerated fed to the kiln 310. Said grinder can be a ball mill that is shown schematically and partially opened in FIG. 2, which ball mill comprises balls 322 placed inside the kiln 310 which, when the kiln 310 rotates, move inside the kiln 310 and, when moving, provide mechanical impacts focused to the green sand for focusing the second mechanical process to the green sand. Because crystal water has been removed from the clay-based binder still possibly in the green sand fraction to be fed to the kiln 310 during the thermo-mechanical process, the binder is more easily released from the surface of the sand grains in this second mechanical process focused to the sand due to the impacts directed at the sand and the mutual rubbing of the sand grains.

In the apparatus of FIG. 2, at least one second processing device 320 has thus been integrated to the kiln 310 for focusing the second mechanical process to at least part of the green sand fraction that has undergone both the first mechanical process and the thermo-mechanical process. However, said at least one second processing device 320 can also be a device separate from the kiln 310 located before the kiln 310 in the flow direction of the sand being regenerated.

The inner wall of the kiln 310 typically includes one or more lifters 312, extending in the direction of the diameter of the kiln 310 from the inner wall of the kiln 310 towards the centre of the kiln and in the longitudinal direction of the kiln 310 substantially from the direction of the first end 310a of the kiln 310 into the direction of the second end 310b of the kiln 310. The lifters 312 are shown very schematically by a dashed line in FIG. 2. Each lifter 312 is arranged, when the kiln 310 rotates around its rotation axis, to catch at least part of the green sand fed to the kiln 310 from the bottom of the kiln 310 along with it such that said part of green sand moves along the kiln 310 on the inner circle of the kiln 310 until the part of the green sand in question and, along with it, the binder released from the sand and other fines possibly in the sand fall back to the bottom of the kiln 310. Said binder and other fines lighter than sand form a flue dust cloud inside the kiln 310, which cloud is removed from the kiln 310 in a way described later in more detail.

The lifters 312 can be arranged to a tilted position schematically shown in FIG. 2 to guide and increase the passing of green sand from the direction of the first end 310a of the kiln 310 towards its second end 310b. A similar effect can be provided or it can be intensified by arranging the kiln 310 in a tilted position such that the first end 310a of the kiln 310 is at a higher position in relation to the second end 310b of the kiln 310, such as schematically shown in the embodiment of FIG. 2. The total inclination degree provided by said position of the lifters 312 and/or the kiln 310 from the first end 310a to the second end 310b of the kiln 310 can be e.g. 0.5-5 degrees. Said degrees are compared to the horizontal level.

The kiln 310 of FIG. 2 additionally comprises at least one air exhaust device 330 which is arranged at the first end 310a of the kiln 310 outside the kiln 310. Alternatively, if possible, the air exhaust device 330 could be at least in some extent be arranged to the inner volume of the kiln 310 at the first end 310a of the kiln 310. Said air exhaust device 330 can be e.g. an air extractor or an exhaust blower. The air exhaust device 330 is arranged, together with an air feed channel 340 arranged at the second end of the kiln 310 leading from outside the kiln 310 to the inner volume of the kiln 310, to produce an air flow which runs from the direction of the second end 310b of the kiln 310 towards the direction of the first end 310a of the kiln 310 and through the air exhaust device 330 out of the kiln 310. Said air flow, which comprises air sucked from the outside environment of the kiln 310, typically of the temperature of the environment of the kiln 310, forms inside the kiln 310 a cooling air flow flowing from the direction of the second end 310b of the kiln 310 into the direction of the first end 310a of the kiln and further through the air exhaust device 330 out of the kiln 310 for cooling the green sand fraction in the kiln 310. Simultaneously, said air flow removes the binder released from the sand and other fines lighter than sand, still possibly remining in the sand from the kiln 310.

The power of the air exhaust device 17 is controlled such that only the binder released from the sand and the other fines still possibly contained by the sand pass along the cooling air flow out of the kiln 310 without carrying sand cleaned from the binder and other impurities. Said binder and fines can be separated in the air flow by means of filter, or such, and guided to further processing. If there is available air cooled to a lower temperature than the temperature of the environment in the surroundings of the kiln 310, this cooled air can also be used for cooling the green sand fraction processed in the kiln 310. The power of the air exhaust device 330 is adjusted e.g. based on the fill factor of the kiln 310 such that the quantity of air flowing through the kiln 310 is e.g. about 1,000-3,000 normal cubic metres per hour.

The regenerated clean sand that has passed the kiln 310, i.e. passed the first mechanical process, the thermo-mechanical process and the second mechanical process, is removed from the kiln 310 at its second end 310b, such as schematically shown by an arrow labelled by F_{AT-OUT} in FIG. 2.

The apparatus 10 of FIG. 2 further comprises at least one classification device 350 which is arranged to receive the green sand fraction that has passed the kiln 310 and to classify it to at least two fractions of regenerated sand different from each other in terms of grain size which are schematically shown by arrows designated by RS1 and RS2 in FIG. 2. Said classification device can comprise e.g. one or more sieves. According to an embodiment, the mesh size of the sieve can be e.g. 2 millimetres, whereby a first fraction RS1 that has passed the screen net can be guided to be utilised for some specific first use, such as e.g. to be re-used as foundry sand, and a second fraction RS2 that has not passed the screen net, i.e. coarse fraction, can be guided to be utilised for some other use.

The solution comprising the first mechanical process, the thermo-mechanical process and the second mechanical process following each other for re-generating green sand regenerates foundry sand, which comprises a clay-based binder, effectively. If an aluminium silicate based additive is added to the sand fraction to be fed to the thermo-mechanical regeneration, it is also possible to effectively remove alkali metals or compounds from the sand being regenerated, which metals and compounds, when remaining on the surface of a sand grain, could prevent the binder from operating when using the regenerated sand and prevent or at least weaken the usability of the regenerated sand e.g. as foundry sand. Furthermore, the recovery of the binder and the carbon released from it in the pre-processing step of the sand being regenerated increases the total quantity of various materials recovered and re-used from the process.

In the apparatus 10 of FIG. 2, at the end of the pre-processing step 100, an additive is added and mixed to a green sand fraction to be fed to the thermo-mechanical processing step 200 to promote the removal of alkali metals or compounds in the clay-based binder still remaining in the green sand being regenerated from the green sand being regenerated in the thermo-mechanical processing step. However, the presented solution can also be utilised in such a method and apparatus wherein no above-mentioned additive is added to the green sand to be fed to the thermo-mechanical processing step 200 but wherein the thermo-mechanical process is focused to the green sand that has undergone the first mechanical process from which, for as great an extent as possible, the clay-based binder and the carbon released in the first mechanical process and preferably also the ferromagnetic material have been removed. When the above-mentioned additive is not added to the green sand to be fed to the thermo-mechanical processing step 200, the removal of alkali metals or compounds in the sand cannot be removed from the sand being regenerated as efficiently. This kind of regenerated sand is still very well applicable for re-utilisation in many different uses, such as e.g. an aggregate in various products, such as concrete, of the building industry.

Those skilled in the art will find it obvious that, as technology advances, the basic idea of the invention may be implemented in many different ways. The invention and its embodiments are thus not restricted to the examples described above but may vary within the scope of the claims.

1-14. (canceled)

15. A method for regenerating green sand, in which method
removing moisture from green sand before focusing a first mechanical process to green sand,
applying the first mechanical process to green sand, wherein green sand is ground in at least one grinder for separating the clay-based binder and carbon in the binder from green sand,
separating from ground green sand by at least one separating device the binder and the carbon released from green sand for forming a green sand fraction that has undergone the first mechanical process,
applying a thermo-mechanical process to at least part of a green sand fraction that has undergone the first mechanical process, and
applying a second mechanical process to at least part of the green sand fraction that has undergone both the first mechanical process and the thermo-mechanical process,
wherein, in the second mechanical process, grinding at least part of the green sand fraction that has undergone both the first mechanical process and the thermo-mechanical process for releasing the clay-based binder from said green sand fraction for forming regenerated green sand that has undergone the first mechanical process, the thermo-mechanical process and the second mechanical process.

16. A method according to claim 15, wherein, in the thermo-mechanical process of green sand, a green sand fraction that has undergone the first mechanical process is fed to a heated rotary kiln, whereby both a mechanical process to separate carbon from the clay-based binder remaining in said green sand fraction and a thermal process for burning said carbon and for evaporating crystal water from the clay-based binder remaining in said green sand fraction are focused.

17. A method according to claim 15, wherein at least one additive is added and mixed to the green sand fraction to be processed thermo-mechanically for increasing the melting temperature of alkali metals or compounds in the green sand, whereby, in said thermo-mechanical process, said at least one additive and the alkali metals or compounds react thus producing partially or totally melted alkali salts which collect sand and impurity particles during the thermo-mechanical process thus forming agglomerates that are separable from the green sand fraction that has undergone the thermo-mechanical process.

18. A method according to claim 17, wherein the agglomerates created in the thermo-mechanical process are separated by at least one separating device out of the green sand fraction that has undergone the thermo-mechanical process before focusing the second mechanical process to the green sand fraction that has undergone both the first mechanical process and the thermo-mechanical process.

19. A method according to claim 17, wherein the additive comprises at least aluminium silicate.

20. A method according to claim 15, wherein
a green sand fraction that has undergone both the first mechanical process and the thermo-mechanical process is fed to at least one grinder,
said green sand fraction is ground for releasing the clay-based binder from the green sand, and
the binder released in the grinding is removed out of the grinder for forming regenerated green sand that has undergone the first mechanical process, the thermo-mechanical process and the second mechanical process.

21. A method according to claim 15, wherein the second mechanical process is performed in a cooling kiln for cooling the sand fraction having heated in the thermo-mechanical process.

22. An apparatus for regenerating green sand, the apparatus comprising
at least one moisture removal device for removing moisture from the green sand to be fed to a first processing device,
at least one first processing device which is arranged to provide mechanical impacts applied to green sand for focusing a first mechanical process to the green sand, wherein the first processing device is a grinder which is arranged to grind the green sand for releasing the clay-based binder from the green sand,
at least one separating device for separating from the ground green sand the binder and the carbon released from it for forming a green sand fraction that has undergone the first mechanical process,
at least one rotatable and heatable rotary kiln for focusing a thermo-mechanical process to at least part of the green sand fraction that has undergone the first mechanical process, and
at least one second processing device which is arranged to provide mechanical impacts applying to green sand for focusing a second mechanical process to at least part of the green sand fraction that has undergone both the first mechanical process and the thermo-mechanical process,
wherein the second processing device is a grinder which is arranged in the second mechanical process to grind at least part of the green sand fraction that has undergone both the first mechanical process and the thermo-mechanical process for releasing the clay-based binder in it for forming regenerated green sand that has undergone the first mechanical process, the thermo-mechanical process and the second mechanical process.

23. An apparatus according to claim 22, wherein the rotatable and heatable rotary kiln is arranged to focus both a mechanical process for separating carbon from the clay-based binder remaining in said green sand fraction and a thermal process for burning said carbon and for evaporating crystal water from the clay-based binder remaining in said green sand fraction to the green sand fraction that has undergone the first mechanical process.

24. An apparatus according to claim 22, wherein the apparatus comprises
at least one dosing device for adding at least one additive to a green sand fraction to be processed in the thermo-mechanical process for increasing the temperature of the melting point of alkali metals or compounds in the green sand, and
at least one mixing device for forming a mix of the green sand fraction processed in the thermo-mechanical process and an additive, whereby, in said thermo-mechanical process, said at least one additive and alkali metals or compounds react thus producing at least partially or totally melted alkali salts which, during the thermo-mechanical process, collect sand and impurity particles thus forming agglomerates separable from the green sand fraction that has undergone the thermo-mechanical process.

25. An apparatus according to claim 24, wherein the apparatus comprises at least one separating device which is arranged to separate the agglomerates created in the thermo-mechanical process out of the green sand fraction that has undergone the thermo-mechanical process before focusing the second mechanical process to the green sand fraction that has undergone the thermo-mechanical process.

26. An apparatus according to claim 22, wherein the apparatus further comprises a cooling kiln, and that
said grinder is a ball mill comprising balls placed inside the cooling kiln which, when the kiln rotates, move inside the kiln and, when moving, provide mechanical impacts focused to the green sand for focusing the second mechanical process to the green sand.
